(19) United States
(12) Patent Application Publication
(10) Pub. No.: US 2023/0258769 A1
(43) Pub. Date: Aug. 17, 2023

(54) SYSTEM OF SENSOR-SPECIFIC REFLECTIVE SURFACES FOR LONG-RANGE SENSOR CALIBRATION

(71) Applicant: GM Cruise Holdings LLC, San Francisco, CA (US)

(72) Inventors: Kenneth Ramon Ferguson, Scottsdale, AZ (US); David Xuan Vu Tran, Denver, CO (US); Zachary Matthew Logan Edwards, San Francisco, CA (US); Philip David Aufdencamp, San Mateo, CA (US)

(73) Assignee: GM Cruise Holdings LLC, San Francisco, CA (US)

(21) Appl. No.: 17/673,004

(22) Filed: Feb. 16, 2022

(51) Int. Cl. G01S 7/40; G01S 13/931; G01S 7/497; G01S 17/931

(52) U.S. Cl. CPC G01S 7/4052; G01S 13/931; G01S 7/497; G01S 17/931; G01S 2013/93271; G05D 1/0088

(57) ABSTRACT

Apparatus and methods are provided for distance calibration of an autonomous vehicle in a nominally short distance calibration environment. In particular, apparatus, methods and systems are provided using reflective materials to artificially augment a distance to a known target. In various implementations, reflective planes are disposed in pathway between the autonomous vehicle and target. Targets of known sizes can be used to calculated a distance from the autonomous vehicle to the target. Utilizing the known optical pathway, a calibration can be performed. With the aid of an Autonomous Vehicle Rotation Table, the autonomous vehicle is rotated such that a matrix of range-angle calibrations can be executed. Frequency spectra include LiDAR and radar, but any suitable bandwidth and/or detection protocol is not beyond the scope of the present disclosure. To this end, a structured calibration environment can be diminished in size, giving rise to more accurate distance calibrations, both intrinsically and extrinsically.

### FIELD OF THE DISCLOSURE

The present disclosure relates generally to the calibration of optical systems used in environment sensing. More specifically, the present disclosure pertains to the calibration of spatial sensing and acquisition found in autonomous vehicles.

### BACKGROUND

An autonomous vehicle (AV) is a vehicle that is configured to navigate roadways based upon sensor signals output by sensors of the AV, wherein the autonomous vehicle navigates the roadways without input from a human. The autonomous vehicle is configured to identify and track objects (such as vehicles, pedestrians, bicyclists, static objects, and so forth) based upon the sensor signals output by the sensors of the autonomous vehicle and perform driving maneuvers (such as accelerating, decelerating, turning, stopping, etc.) based upon the identified and tracked objects.

The use of automation in the driving of road vehicles, such as, cars, trucks, and others, has increased as a result of advances in sensing technologies (e.g., object detection and location tracking), control algorithms, and data infrastructures. By combining various enabling technologies like adaptive cruise control (ACC), lane keeping assistance (LKA), electronic power assist steering (EPAS), adaptive front steering, parking assistance, antilock braking (ABS), traction control, electronic stability control (ESC), blind spot detection, GPS and map databases, vehicle to vehicle communication, and other, it becomes possible to operate a vehicle autonomously (i.e., with little or no intervention by a driver).

In the field of autonomous or quasi-autonomous operation of vehicles such as aircrafts, watercrafts or land vehicles, in particular automobiles, which may be manned or unmanned, sensing the surrounding of the vehicle as well as tracking objects in the surrounding of the vehicle may be considered to be crucial for sophisticated functionalities. These functionalities may range from driver assistance systems in different stages of autonomy up to full autonomous driving of the vehicle.

In certain environments, a plurality of different types of sensors for sensing the surrounding of a vehicle are used, such as monoscopic or stereoscopic cameras, light detection and ranging (LiDAR) sensors, and radio detection and ranging (radar) sensors. The different sensor types comprise different characteristics that may be utilized for different tasks.

### SUMMARY

Apparatus and methods are provided for distance calibration of an autonomous vehicle in a nominally short distance calibration environment. In particular, apparatus, methods and systems are provided using reflective materials to artificially augment a distance to a known target. In various implementations, reflective planes are disposed in a pathway between the autonomous vehicle and the target. Targets of known sizes can be used to calculate a distance from the autonomous vehicle to the target. Utilizing the known optical pathway, a calibration can be performed. With the aid of an Autonomous Vehicle Rotation Table, the autonomous vehicle is rotated such that a matrix of range-angle calibrations can be executed. Frequency spectra include LiDAR and radar, but any suitable bandwidth and/or detection protocol is not beyond the scope of the present disclosure. To this end, a structured calibration environment can be diminished in size, giving rise to more accurate distance calibrations, both intrinsically and extrinsically.

According to one aspect of the present disclosure, a system for calibrating an autonomous vehicle comprises a platform configured to rotate the autonomous vehicle, the autonomous vehicle comprising an emitter and a receiver, a first reflective medium configured to reflect electromagnetic radiation from the emitter, and a target, wherein the first reflective medium is disposed in a pathway between the target and autonomous vehicle.

According to one or more aspects of the present disclosure, emitter and receiver are configured to send and receive LiDAR signals.

According to one or more aspects of the present disclosure, emitter and receiver are configured to send and receive radar signals.

According to one or more aspects of the present disclosure, the target is a radar reflector.

According to one or more aspects of the present disclosure, the target is a boat reflector.

According to one or more aspects of the present disclosure, the target is a radar target enhancers (RTE).

According to one or more aspects of the present disclosure, the target is a trihedral.

According to one or more aspects of the present disclosure, the reflective medium is a metal plane.

According to one or more aspects of the present disclosure, the emitter and receiver are configured to send and receive LiDAR signal.

According to one or more aspects of the present disclosure, the emitter and receiver are configured to send and receive optical signals.

According to one or more aspects of the present disclosure, the target comprises and a symbol or code configured to be identifiable by the autonomous vehicle.

According to one or more aspects of the present disclosure, the system further comprises a second reflective medium.

According to one or more aspects of the present disclosure, at least one of the first and second reflective media is a mirror.

According to one aspect of the present disclosure, a method for calibrating an autonomous vehicle comprises emitting an electromagnetic wave from an autonomous vehicle, illuminating a reflect medium with the electromagnetic wave, reflecting the electromagnetic wave off the reflective medium, illuminating a target with the reflected electromagnetic wave, receiving the reflected electromagnetic wave at the autonomous vehicle, and calculating a distance based at least on the reflected electromagnetic wave.

According to one or more aspects of the present disclosure, the method further comprising rotating the autonomous vehicle.

According to one or more aspects of the present disclosure, the electromagnetic wave has a spectral bandwidth within at least one of the radar, visible, IR, UV, and LiDAR regions.

According to one or more aspects of the present disclosure, the reflective media is a radar trihedral.

According to one or more aspects of the present disclosure, the electromagnetic wave comprises a plurality of colors.

According to one or more aspects of the present disclosure, the reflective media is a mirror.

According to one or more aspects of the present disclosure, the target comprises a symbol, such as an alphanumeric character or QR code.

According to one or more aspects of the present disclosure, the method further comprising imaging the symbol.

According to one or more aspects of the present disclosure, the calculation of distance is based at least on a size of the symbol.

According to one aspect of the present disclosure, a system for calibrating an autonomous vehicle comprising a means for emitting an electromagnetic wave from an autonomous vehicle, means for illuminating a reflect medium with the electromagnetic wave, a means for reflecting the electromagnetic wave off the reflective medium, a means for illuminating a target with the reflected electromagnetic wave, a means for receiving the reflected electromagnetic wave at the autonomous vehicle, and a means for calculating a distance based at least on the reflected electromagnetic wave.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a diagram illustrating an autonomous vehicle, according to some embodiments of the disclosure;

FIG. 2 is a diagram illustrating an example of an autonomous vehicle chassis having multiple optical sensors, according to various embodiments of the disclosure;

FIG. 3 depicts a performed exemplary calibration environment in practice, according to one or more embodiments of the disclosure;

FIG. 4 illustrates an exemplary calibration configuration, according to one or more embodiments of the disclosure;

FIG. 5 illustrates an alternate exemplary calibration configuration, according to other embodiments of the disclosure;

FIG. 6 illustrates an alternate exemplary calibration configuration, according to other embodiments of the disclosure; and

FIG. 7 depicts an exemplary corner reflector, according to some embodiments of the disclosure.

### DETAILED DESCRIPTION

Overview

Apparatus, systems, and methods are provided for the calibration of optical systems used in environment sensing. More specifically, the present disclosure provides the calibration of spatial sensing and acquisition found in autonomous vehicles. Calibration comprises disposing an autonomous vehicle in a testing scene which includes unique targets at predetermined distances. Calibration is performed in structured set-up by comparing detected pathlength distances with predetermined distances.

When produced, spatial sensors and spatial sensor systems exhibit differences during production. Variances can stem from differences in manufacturing runs to doping of semiconductors materials. As such sensors require some calibration before installation. This is called intrinsic calibration.

Geometric calibration, also referred to as resectioning, estimates the parameters of image spatial sensor. Parameters are used to correct for distortion, measure the size of an object in world units, or determine the location of the spatial sensor in the scene. These tasks are used in applications such as machine vision to detect and measure objects. They are also used in robotics, for navigation systems, and 3-D scene reconstruction.

Sensor parameters include intrinsics, extrinsics, and distortion coefficients. To estimate the parameters, it is desired to have three-dimensional (3-D) world points to correspond to two-dimensional (2-D) image points. Typically, correspondences can be made using multiple images and/or target patterns. Using the correspondences, parameters can be solved. After a sensor is calibrated, accuracy is evaluated using the estimated parameters.

Intrinsic calibrations are burdensome and costly. Furthermore, intrinsic calibrations do not account for vehicle placement, application, disparities among sensors systems, or other unforeseen implementations. Extrinsic calibration aims to obtain the extrinsic parameters that define the rigid relationship, that is, the rotation matrix and translation vector between two coordinate systems. The inventors of the present disclosure contemplate improving intrinsic calibrations by creating an artificially large scene thereby lessening the need for less accurate extrinsic calibration.

The inventors of the present disclosure have identified numerous shortcomings found in the state of the art. Previous efforts consist placement of an autonomous vehicle in a structured scene. The scene is limited by the artificially geometric footprint. As such, distance calibrations are limited to the boundary conditions of the structured scene. The inventors of the present disclosure have recognized the long felt need for a more robust calibration technique to correct for calibration environments exhibiting less than desirable parameters to overcome the deficiencies of the state of the art, at least in part.

Example Autonomous Vehicle Configured for Environmental Optical Sensing

Autonomous vehicles, also known as self-driving cars, driverless vehicles, and robotic vehicles, are vehicles that use multiple sensors to sense the environment and move without human input. Automation technology in the autonomous vehicles enables the vehicles to drive on roadways and to accurately and quickly perceive the vehicle's environment, including obstacles, signs, and traffic lights. The vehicles can be used to pick up passengers and drive the passengers to selected destinations. The vehicles can also be used to pick up packages and/or other goods and deliver the packages and/or goods to selected destinations. Autonomous vehicles rely heavily on optical systems which are accurate for classification. That is, the vehicle relies upon this analysis to distinguish between threats and benign classification of targets.

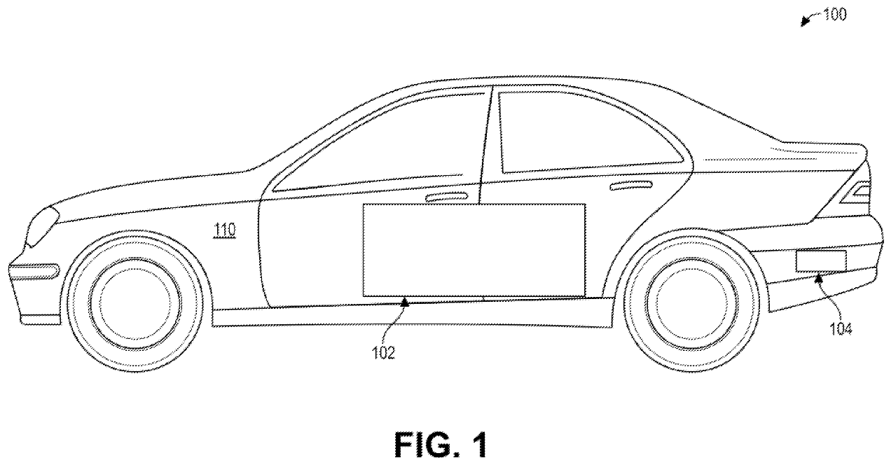

FIG. 1 is a diagram 100 illustrating an autonomous vehicle 110, according to some embodiments of the disclosure. The autonomous vehicle 110 includes a sensor suite 102 and an onboard computer 104. In various implementations, the autonomous vehicle 110 uses sensor information from the sensor suite 102 to determine its location, to navigate traffic, and to sense and avoid obstacles. According to various implementations, the autonomous vehicle 110 is part of a fleet of vehicles for picking up passengers and/or packages and driving to selected destinations.

The sensor suite 102 includes localization and driving sensors. For example, the sensor suite may include one or more of photodetectors, cameras, radar, sonar, lidar, GPS, inertial measurement units (IMUs), accelerometers, microphones, strain gauges, pressure monitors, barometers, thermometers, altimeters, wheel speed sensors, and a computer vision system. The sensor suite 102 continuously monitors the autonomous vehicle's environment and, in some examples, sensor suite 102 data is used to detect selected events, and update a high-fidelity map. In particular, data from the sensor suite can be used to update a map with information used to develop layers with waypoints identifying selected events, the locations of the encountered events, and the frequency with which the events are encountered at the identified location. In some examples, the events include road hazard data such as locations of pot holes or debris. In this way, sensor suite 102 data from many autonomous vehicles can continually provide feedback to the mapping system and the high-fidelity map can be updated as more and more information is gathered.

The sensor suite 102 includes a plurality of sensors and is coupled to the onboard computer 104. In some examples, the onboard computer 104 receives data captured by the sensor suite 102 and utilizes the data received from the sensors suite 102 in controlling operation of the autonomous vehicle 110. In some examples, one or more sensors in the sensor suite 102 are coupled to the vehicle batteries, and capture information regarding a state of charge of the batteries and/or a state of health of the batteries.

In various examples, the sensor suite 102 includes cameras implemented using high-resolution imagers with fixed mounting and field of view. In further examples, the sensor suite 102 includes lidars implemented using scanning lidars. Scanning lidars have a dynamically configurable field of view that provides a point-cloud of the region intended to scan. In still further examples, the sensor suite 102 includes radars implemented using scanning radars with dynamically configurable field of view. In some examples, the sensor suite 102 records information relevant to vehicle structural health. In various examples, additional sensors are positioned within the vehicle, and on other surfaces on the vehicle. In some examples, additional sensors are positioned on the vehicle chassis.

The autonomous vehicle 110 includes an onboard computer 104, which functions to control the autonomous vehicle 110. The onboard computer 104 processes sensed data from the sensor suite 102 and/or other sensors, in order to determine a state of the autonomous vehicle 110. In some implementations described herein, the autonomous vehicle 110 includes sensors inside the vehicle. In some examples, the autonomous vehicle 110 includes one or more cameras inside the vehicle. The cameras can be used to detect items or people inside the vehicle. In some examples, the autonomous vehicle 110 includes one or more weight sensors inside the vehicle, which can be used to detect items or people inside the vehicle. Based upon the vehicle state and programmed instructions, the onboard computer 104 controls and/or modifies driving behavior of the autonomous vehicle 110.

The onboard computer 104 functions to control the operations and functionality of the autonomous vehicle 110 and processes sensed data from the sensor suite 102 and/or other sensors in order to determine states of the autonomous vehicle. In some implementations, the onboard computer 104 is a general-purpose computer adapted for I/O communication with vehicle control systems and sensor systems. In some implementations, the onboard computer 104 is any suitable computing device. In some implementations, the onboard computer 104 is connected to the Internet via a wireless connection (e.g., via a cellular data connection). In some examples, the onboard computer 104 is coupled to any number of wireless or wired communication systems. In some examples, the onboard computer 104 is coupled to one or more communication systems via a mesh network of devices, such as a mesh network formed by autonomous vehicles.

According to various implementations, the autonomous driving system 100 of FIG. 1 functions to enable an autonomous vehicle 110 to modify and/or set a driving behavior in response to parameters set by vehicle passengers (e.g., via a passenger interface) and/or other interested parties (e.g., via a vehicle coordinator or a remote expert interface). Driving behavior of an autonomous vehicle may be modified according to explicit input or feedback (e.g., a passenger specifying a maximum speed or a relative comfort level), implicit input or feedback (e.g., a passenger's heart rate), or any other suitable data or manner of communicating driving behavior preferences.

The autonomous vehicle 110 is preferably a fully autonomous automobile, but may additionally or alternatively be any semi-autonomous or fully autonomous vehicle. In various examples, the autonomous vehicle 110 is a boat, an unmanned aerial vehicle, a driverless car, a golf cart, a truck, a van, a recreational vehicle, a train, a tram, a three-wheeled vehicle, or a scooter. Additionally, or alternatively, the autonomous vehicles may be vehicles that switch between a semi-autonomous state and a fully autonomous state and thus, some autonomous vehicles may have attributes of both a semi-autonomous vehicle and a fully autonomous vehicle depending on the state of the vehicle.

In various implementations, the autonomous vehicle 110 includes a throttle interface that controls an engine throttle, motor speed (e.g., rotational speed of electric motor), or any other movement-enabling mechanism. In various implementations, the autonomous vehicle 110 includes a brake interface that controls brakes of the autonomous vehicle 110 and controls any other movement-retarding mechanism of the autonomous vehicle 110. In various implementations, the autonomous vehicle 110 includes a steering interface that controls steering of the autonomous vehicle 110. In one example, the steering interface changes the angle of wheels of the autonomous vehicle. The autonomous vehicle 110 may additionally or alternatively include interfaces for control of any other vehicle functions, for example, windshield wipers, headlights, turn indicators, air conditioning, etc.

Example Vehicle Front with Optical Sensors

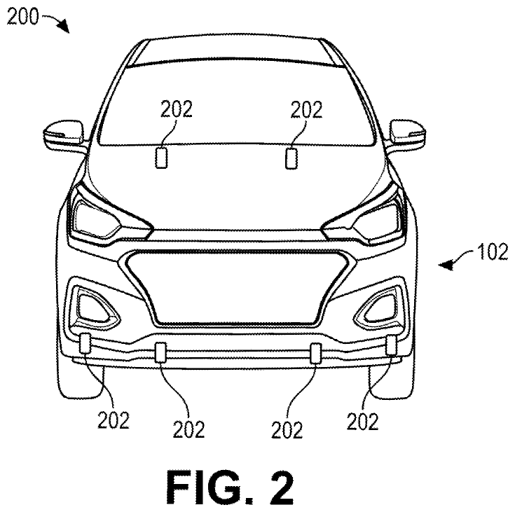

FIG. 2 is a diagram illustrating an example of a front of an autonomous vehicle 200 with multiple optical systems 202, according to various embodiments of the invention. The optical systems 202 can be positioned underneath the fascia of the vehicle, such that they are not visible from the exterior. In various implementations, more or fewer optical systems 202 are included on the vehicle 200, and in various implementations, the optical systems 202 are located in any selected position on or in the vehicle 200. The optical systems 202 measure structural integrity of the frame and other structural elements of the autonomous vehicle 200, as described above. As described above with respect to the transducers 204 of FIG. 1, in various examples, one or more of the optical systems 202 are lidar devices.

LiDAR is a method for determining ranges (variable distance) by targeting an object with a laser and measuring the time for the reflected light to return to the receiver. LiDAR can also be used to make digital 3D representations of areas on the earth's surface and ocean bottom, due to differences in laser return times, and by varying laser wavelengths. It has terrestrial, airborne, and mobile applications. LiDAR is an acronym of “light detection and ranging” or “laser imaging, detection, and ranging”. LiDAR sometimes is called 3D laser scanning, a special combination of 3D scanning and laser scanning.

In other embodiments, other time-of-flight (ToF) systems, such as an RGB camera, can be implemented. A time-of-flight camera (ToF camera) is a range imaging camera system employing time-of-flight techniques to resolve distance between the camera and the subject for each point of the image, by measuring the round-trip time of an artificial light signal provided by a laser or an LED. Laser-based time-of-flight cameras are part of a broader class of scannerless lidar, in which the entire scene is captured with each laser pulse, as opposed to point-by-point with a laser beam such as in scanning lidar systems. Time-of-flight camera systems can cover ranges of a few centimeters up to several kilometers.

In yet other embodiments, calibration techniques are applicable to optical imaging which uses light and special properties of photons to obtain detailed images. Other applications, such as, spectroscopy, are also not beyond the scope of the present disclosure.

In various implementations, additional optical systems 202 are positioned along the sides of an autonomous vehicle, and at the rear of the autonomous vehicle. These optical systems 202 may be uses as induvial devices or collaboratively, as in a plurality of differing types or an array of the same type, such as, a phased array.

Responses among the various optical systems 202 are used to determine the surrounding environment and moving safely with little or no human input. To that end, sensor suite 102 combines a variety of sensors to perceive vehicle surroundings, such as radar, lidar, sonar, GPS, odometry and inertial measurement units. Advanced control systems interpret sensory information to identify appropriate navigation paths, as well as obstacles and relevant signage.

Example Vehicle with Differing Sensor Systems in a Calibration Scene

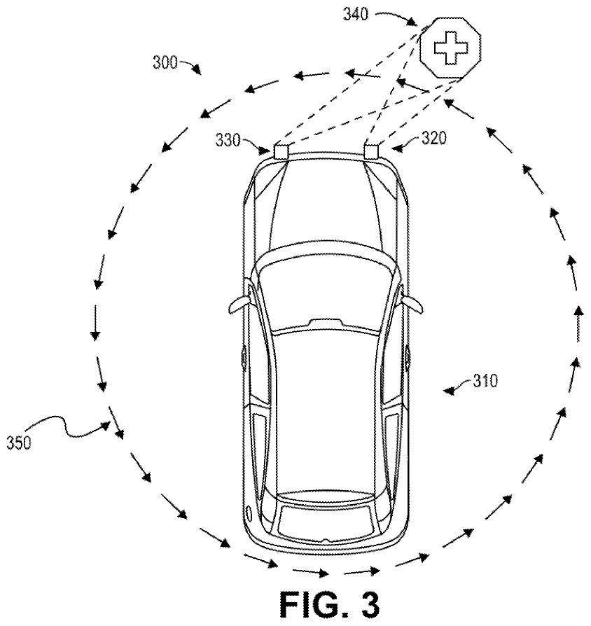

FIG. 3 depicts a desirable exemplary calibration environment 300 in practice, according to one or more embodiments of the disclosure. FIG. 3 diagrams an autonomous vehicle 310 with multiple spatial systems, according to various embodiments of the invention. According to one embodiment, a first spatial system is LiDAR 320 and a second spatial system is radar 330.

The combination of a radar and lidar can be widely used in robotics, mapping, and unmanned driving to simultaneously obtain the 3D geometry and landscape of a scene. However, data misregistration between the radar and lidar frequently occurs due to the difficulty of precise installation and alignment between them. More precise calibration between the lidar and radar is necessary. In the present disclosure, a radar and/or LiDAR target is used to perform a robust and accurate calibration between the LiDAR and and/or radar target.

Embodiments of the present disclosure concern aspects of processing measurement data of radar systems, whereby the inaccuracies of sensor data (e.g., range, angle and velocity) can be calibrated. This is particularly useful, when two or more spatial sensing systems need to be extrinsically calibrated by correlation.

Radar systems typically provide measurement data, in particular range, doppler, and/or angle measurements (azimuth and/or elevation), with high precision in a radial direction. This allows one to accurately measure (radial) distances as well as (radial) velocities in a field of view of the radar system between different reflection points and the (respective) antenna of the radar system.

Radar systems transmit (emit) radar signals into the radar system's field of view, wherein the radar signals are reflected off of objects that are present in the radar system's field of view and received by the radar system. The transmission signals are, for instance, frequency modulated continuous wave (FMCW) signals. Radial distances can be measured by utilizing the time-of-flight travel of the radar signal, wherein radial velocities are measured by utilizing the frequency shift caused by the doppler effect.

By repeating the transmitting and receiving of the radar signals, radar systems are able to observe the radar system's field of view over time by providing measurement data comprising multiple, in particular consecutive, radar frames. An individual radar frame may for instance be a range-azimuth-frame or a range-doppler-azimuth-frame. A range-doppler-azimuth-elevation-frame would be also conceivable, if data in the elevation-direction is available.

In each of the multiple radar frames a plurality of reflection points which may form clouds of reflection points can be detected. However, the reflection points or point clouds, respectively, in the radar frames do not contain a semantic meaning per se. Accordingly, a semantic segmentation of the radar frames is necessary in order to evaluate (“understand”) the scene of the vehicle's surroundings.

The segmentation of a radar frame means that the single reflection points in the individual radar frames are assigned a meaning. For instance, reflection points may be assigned to the background of the scene, foreground of the scene, stationary objects such as buildings, walls, parking vehicles or parts of a road, and/or moving objects such as other vehicles, cyclists and/or pedestrians in the scene.

Generally, radar systems observe specular reflections of the transmission signals that are emitted from the radar system, since the objects to be sensed tend to comprise smoother reflection characteristics than the (modulated) wavelengths of the transmission signals. Consequently, the obtained radar frames do not contain continuous regions representing single objects, but rather single prominent reflection points (such as the edge of a bumper), distributed over regions of the radar frame.

Radar data form of 3-dimensional, complex-valued array (a.k.a. radar cube) with dimensions corresponding to azimuth (angle), radial velocity (doppler), and radial distance (range). Taking the magnitude in each angle-doppler-range bin describes how much energy the radar sensor sees coming from that point in space (angle and range) for that radial velocity.

Turning to FIG. 3, autonomous vehicle 310 comprises LiDAR 320 and radar 330. In practice, the autonomous vehicle 310 is disposed on an Autonomous Vehicle Rotation Table. As may be known by one or ordinary skill in the art, Autonomous Vehicle Rotation Table is a is a turntable which functionally serves to spin an automobile in the radial direction. Autonomous Vehicle Rotation Table 350 comprises a rotatable circle; however, any other suitable dynamic rotation and/or motion is not beyond the scope of the present disclosure.

In practice, autonomous vehicle 310 revolves upon the Autonomous Vehicle Rotation Table 340. During rotation, spatial sensors (e.g., LiDAR 320 and radar 330) attempt to identify and measure the target 340. In some embodiments, target 340 is unique in order to mitigate confusion with other target, which will be discussed presently. In one or more embodiments, the optical image on the target resembles a letter or symbol. While in other embodiments, the optical shape displayed on target 340 resembles a QR code.

A QR code (an initialism for Quick Response code) is a type of matrix barcode (or two-dimensional barcode). A barcode is a machine-readable optical label that can contain information about the item to which it is attached. In practice, QR codes often contain data for a locator, identifier, or tracker that points to a website or application. A QR code uses four standardized encoding modes (numeric, alphanumeric, byte/binary, and kanji) to store data efficiently; extensions may also be used.

Upon identification, autonomous vehicle 310 spatial sensors, such as, LiDAR 320 and optical imaging, etc. perform a plurality of measurements. The measurements comprise calculation of distance and size estimation of the target 340 image, inter cilia. The amalgam is used in comparison to a reference distance to the target 340. That is, the reference distance represents a predetermined distance along an optical pathway between the sensor and the target. A simple embodiment is described as follows.

AV 310 optically scans the scene. This can be performed either statically or dynamically, as in rotation upon the Autonomous Vehicle Rotation Table 340. The optical scan identifies a predetermined symbol on the target 340, such as, a bloated plus symbol depicted in FIG. 3. In imaging the symbol, pixels can be used to estimate height and width. Parenthetically, a 3-dimensional projection can easily be engendered, which is also with the scope of the present invention. By way of one or more dimensional estimations of predetermined symbol on the target 340, a distance from the target 340 can be provisionally estimated.

Also, in practice during a calibration, LiDAR 320 scans the surrounding environment and identifies target 340. Radar 330 uses this information to search for radar point clouds in the general location where the LiDAR 320 identified the target. Because LiDAR is accurate in ranging, the resulting information can be used to calibrate the radar 330, at least in part. Additionally, this makes processing the data permissible in a real time environment, as segmentation need only be performed on the area identified by the LiDAR 320.

In some embodiments, the target comprises a retroreflective surface, at least in part. Retroreflection occurs when a surface returns a large portion of directed light beam back to its source. Retroreflective materials appear brightest to observers nearest the light source (such as a motorist). The object's brightness depends on the intensity of the light striking the object and the materials the object is made of. Predetermined patterns, such as, bars can be used to help identify a target. However, any shape and configuration are not beyond the scope of the present disclosure.

In some implementations, the retroreflective material comprises truncated cube or high intensity prismatic sign reflective sign sheeting which is noticeably brighter and more legible at a greater distance. In other implementations, glass-bead retroreflection target sheeting is used, wherein an incoming light beam bends as it passes through a glass bead, reflects off a mirrored surface behind the bead, then the light bends again as it passes back through the bead and returns to the light source. In yet other implementations, cube corner retroreflection target sheeting is used. This technology returns light more efficiently than glass beads. With this technology, each cube corner has three carefully angled reflective surfaces. Incoming light bounces off all three surfaces and returns to its source.

While some embodiments implement retroreflective materials, mirror reflection and diffuse are not beyond the scope of the present disclosure.

One problem in the art arising with intrinsic calibration is the large geographic footprint. As can be appreciated by one skilled in the art, targets cannot be placed at arbitrary distances. Boundary conditions limit the accuracy on scenic calibrations.

Example Analysis Using Geometric Optics

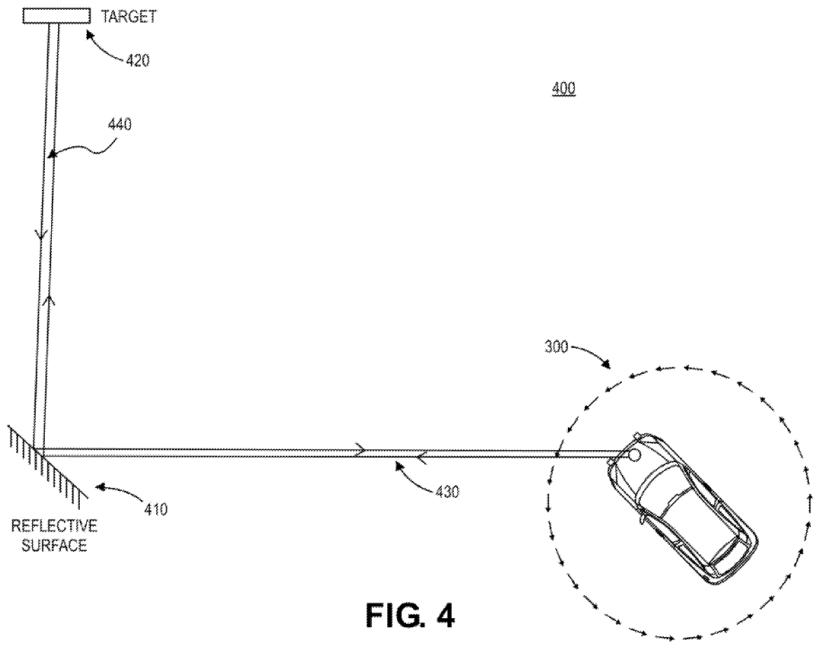

FIG. 4 illustrates an exemplary calibration configuration, according to one or more embodiments of the disclosure. FIG. 4 is a diagram illustrating fundamental geometric optical modeling 400, according to some embodiments of the disclosure. Geometrical optics, or ray optics, is a model of optics that describes light propagation in terms of rays. The ray in geometric optics is an abstraction useful for approximating the paths along which light propagates under certain circumstances. The simplifying assumptions of geometrical optics include that light rays: propagate in straight-line paths as they travel in a homogeneous medium; bend, and in particular circumstances may split in two, at the interface between two dissimilar media; follow curved paths in a medium in which the refractive index changes; and may be absorbed or reflected.

Geometrical optics does not account for certain optical effects such as diffraction and interference. This simplification is useful in practice; it is an excellent approximation when the wavelength is small compared to the size of structures with which the light interacts. The techniques are particularly useful in describing geometrical aspects of imaging, including optical aberrations. While the present disclosure describes geometric optics, Gaussian optics are not beyond the scope of the embodiments.

Gaussian optics is a technique in geometrical optics that describes the behavior of light rays in optical systems by using the paraxial approximation, in which only rays which make small angles with the optical axis of the system are considered. In this approximation, trigonometric functions can be expressed as linear functions of the angles. Gaussian optics applies to systems in which all the optical surfaces are either flat or are portions of a sphere. In this case, simple explicit formulae can be given for parameters of an imaging system such as focal length, magnification and brightness, in terms of the geometrical shapes and material properties of the constituent elements.

In geometric optics, the paraxial approximation is a small-angle approximation used in Gaussian optics and ray tracing of light through an optical system (such as a lens). A paraxial ray is a ray which makes a small angle (θ) to the optical axis of the system and lies close to the axis throughout the system. Generally, this allows three important approximations (for θ in radians) for calculation of the ray's path.

Turning to FIG. 4, the inventors of the present disclosure heuristically bootstrap the didactic guidance from FIG. 3 with the inclusion of Autonomous Vehicle Rotation Table calibration environment 300. In one or more embodiments, the electromagnetic wave pathway is increased by way of reflective surface 410. In a simple optical embodiment, autonomous vehicle can read the target 420 and estimate the distance solely based on return path 440.

In one or more embodiments, reflective surface 410 is a mirror. A mirror is an object that reflects an image. Light that bounces off a mirror will show an image of whatever is in front of it, when focused through the lens of the eye or a camera. Mirrors reverse the direction of the image in an equal yet opposite angle from which the light shines upon it. This allows the viewer to see themselves or objects behind them, or even objects that are at an angle from them but out of their field of view, such as around a corner. Natural mirrors have existed since prehistoric times, such as the surface of water, but people have been manufacturing mirrors out of a variety of materials for thousands of years, like stone, metals, and glass. In modern mirrors, metals like silver or aluminum are often used due to their high reflectivity, applied as a thin coating on glass because of its naturally smooth and very hard surface.

A mirror is a wave reflector. Light consists of waves, and when light waves reflect off the flat surface of a mirror, those waves retain the same degree of curvature and vergence, in an equal yet opposite direction, as the original waves. This allows the waves to form an image when they are focused through a lens, just as if the waves had originated from the direction of the mirror. The light can also be pictured as rays (imaginary lines radiating from the light source, that are always perpendicular to the waves). These rays are reflected at an equal yet opposite angle from which they strike the mirror (incident light). This property, called specular reflection, distinguishes a mirror from objects that diffuse light, breaking up the wave and scattering it in many directions (such as flat-white paint). Thus, a mirror can be any surface in which the texture or roughness of the surface is smaller (smoother) than the wavelength of the waves.

While the present embodiment, the reflective surface 410 is a mirror, any suitable reflective media is not beyond the scope of the current of the current disclosure. Specifically, any surface that reflects the electro-magnetic wave of interest can be used. In more technical terms, any media such that the real part of the impedance is not matched (e.g., with air) or is has a complex impedance can be used. In other words, the media does not have an index of refraction very close to air, nor is the medium very lossy. Some examples are enumerated as follows.

In one or more embodiments, the reflective media half-silvered mirror. A half-silvered mirror is a reciprocal mirror that appears reflective on one side and transparent at the other. In other embodiments, the reflective media is a beamsplitter, such as, a 50/50 beamsplitter. Beamsplitters are optical components used to split incident light at a designated ratio into two separate beams. Additionally, beamsplitters can be used in reverse to combine two different beams into a single one.

In some embodiments, the beamsplitter is a plate beamsplitter. Plate beamsplitters consist of a thin, flat glass plate that has been coated on the first surface of the substrate. Most plate beamsplitters feature an anti-reflection coating on the second surface to remove unwanted Fresnel reflections. Plate beamsplitters are often designed for a 45° angle of incidence (AOI). In other embodiments, the AOI can be configured for any suitable geometry based on the testing setup.

In some embodiments, the beamsplitter is a cube beamsplitter. Cube beamsplitters are constructed using two typically right-angle prisms. The hypotenuse surface of one prism is coated, and the two prisms are cemented together so that they form a cubic shape. To avoid damaging the cement, it is recommended that the light be transmitted into the coated prism, which often features a reference mark on the ground surface.

Standard Beamsplitters are commonly used with unpolarized light sources, such as natural or polychromatic, in applications where polarization state is not important. They are designed to split unpolarized light at a specific Reflection/Transmission (R/T) ratio with unspecified polarization tendencies.

In some embodiments, the beamsplitter is a polarizing beam splitter (PBS). Polarizing beamsplitters are designed to split light into reflected S-polarized and transmitted P-polarized beams. They can be used to split unpolarized light at a 50/50 ratio, or for polarization separation applications such as optical isolation. A PBS may be useful wherein the source is polarized.

In other embodiments, the beamsplitter is a non-polarizing beamsplitter. Non-polarizing beamsplitters split light into a specific R/T ratio while maintaining the incident light's original polarization state. For example, in the case of a 50/50 non-polarizing beamsplitter, the transmitted P and S polarization states and the reflected P and S polarization states are split at the design ratio. These beamsplitters are ideal for maintaining polarization in applications utilizing polarized light.

In yet other embodiments, the beamsplitter is a dichroic beamsplitter. Dichroic beamsplitters split light by wavelength. Options range from laser beam combiners designed for specific laser wavelengths to broadband hot and cold mirrors for splitting visible and infrared light. This type of beamsplitter is commonly used in fluorescence applications.

In other embodiments, the reflective media is a prism. An optical prism is a transparent optical element with flat, polished surfaces that are designed to refract light. At least one surface must be angled—elements with two parallel surfaces are not prisms. The traditional geometrical shape of an optical prism is that of a triangular prism with a triangular base and rectangular sides, and in colloquial use “prism” usually refers to this type. Some types of optical prism are not in fact in the shape of geometric prisms. Prisms can be made from any material that is transparent to the wavelengths for which they are designed. Typical materials include glass, acrylic and fluorite.

In other embodiment, the reflective media is a total internal reflector. Total internal reflection (TIR) is the optical phenomenon in which waves arriving at the interface (boundary) from one medium to another (e.g., from water to air) are not refracted into the second (“external”) medium, but completely reflected back into the first (“internal”) medium. It occurs when the second medium has a higher wave speed (lower refractive index) than the first, and the waves are incident at a sufficiently oblique angle on the interface. Specifically, the construction of the total internal reflector would have two or more layers of media, such as, the cladding which surrounds a fiber optic core.

In some embodiments, the reflective media comprises a dichroic filter. A dichroic filter, thin-film filter, or interference filter is a very accurate color filter used to selectively pass light of a small range of colors while reflecting other colors. By comparison, dichroic mirrors and dichroic reflectors tend to be characterized by the color(s) of light that they reflect, rather than the color(s) they pass.

While a dichroic filter is used in the present embodiment, other optical filters are not beyond the scope of the present invention, such as, interference, absorption, diffraction, grating, Fabry-Perot, etc. An interference filter consists of multiple thin layers of dielectric material having different refractive indices. There also may be metallic layers. In its broadest meaning, interference filters comprise also etalons that could be implemented as tunable interference filters. Interference filters are wavelength-selective by virtue of the interference effects that take place between the incident and reflected waves at the thin-film boundaries.

In other embodiments the reflective media comprises a thin film interference filter. Thin-film optical filters are made by depositing alternating thin layers of materials with special optical properties onto a substrate, such as optical-grade glass. As light makes its way through the optical filter, its direction changes as it passes from one layer to the next, resulting in internal interference. This is due to the differences between the refractive indices of the materials in the dielectric thin-film coating. The configuration of the layers results in an optical filter that manipulates different wavelengths of light in different ways. Depending on the wavelength and type of optical filter, light can be reflected off of the filter, transmitted through it, or absorbed by it.

Depending on desired configuration, optical filters can be designed to transmit, block, or reflect light at any wavelength range from the UV to the IR. Specifically, the optical filter can comprise one or more of the following. Bandpass filters transmit a range of wavelengths while blocking the adjacent light on either side. Notch filters block a range of wavelengths while transmitting the light on either side. Shortpass edge filters transmit shorter wavelengths while blocking longer ones. Longpass edge filters block shorter wavelengths while transmitting longer ones.

Bandpass, notch, and edge filters are generally designed to work at 0° or other small angles of incidence (AOI). Dichroic filters, on the other hand, are meant to be used at 45° or other large AOI and can be designed in bandpass, notch, or edge configurations. However, any AOI is not beyond the scope of the present disclosure.

Optical filters can also be designed in multiband configurations. Multiband filters are bandpass filters with more than one passband, or region of high transmission. Multi-notch filters have more than one blocking region and transmit all adjacent light. Polychroic filters are dichroic filters that have multiple bands or notches.

In other embodiments, the reflective media comprises a polarizing filter. A polarized filter passes only the light that does not match its orientation. Only the part of the light wave that is not aligned with its slots in the filter can pass through. Everything else is absorbed. The light coming through the filter is considered polarized.

Polarized filters are most commonly made of a chemical film applied to a transparent plastic or glass surface. The chemical compound used will typically be composed of molecules that naturally align in parallel relation to one another. When applied uniformly to the lens, the molecules create a microscopic filter that absorbs any light matching their alignment. This may be useful in separating transverse magnetic (TM) from transverse electric (TE) polarizations.

In some embodiments, the reflective media exhibits the electro-optic effect. An electro-optic effect is a change in the optical properties of a material in response to an electric field that varies slowly compared with the frequency of light. In particular, the reflective media changes one or more of the following parameters, absorption, refractive index and permittivity, as a function of an externally applied electric field.

In other embodiments, the reflective media is birefringent. Birefringence is the optical property of a material having a refractive index that depends on the polarization and propagation direction of light. These optically anisotropic materials are said to be birefringent (or birefractive). The birefringence is often quantified as the maximum difference between refractive indices exhibited by the material. Crystals with non-cubic crystal structures are often birefringent, as are plastics under mechanical stress.

In yet other embodiments, the reflective media is a heterostructure, such as, a quantum well or superlattice. Superlattices are periodic structures of repeating wells. Typically, the e periodic structure layers of two (or more) materials having a layer thickness of several nanometers.

In general, the reflective media can be any smooth surface which exhibits a non-zero reflectivity for a particular wavelength at a specified AOI and polarization. As can be appreciated by one of ordinary skill in the art, these can be simply calculated using Snell's law and Fresnel equations.

In projection systems, LiDAR is projected on an outgoing pathway 430. The optical pathway is reflected upon incidence of reflective surface 410. In some embodiments, the reflection is lossless; however, this is largely unnecessary, as any lossy and/or evanescent media is not beyond the scope of the present disclosure. Outgoing pathway 430 is incident upon target 420 after reflection on reflective surface 410. Pathway 430 is then incident on target 420. Pursuant to Snell's law and color absorption, a return pathway 440 is engendered. The return pathway 440 becomes incident on reflective surface 410 which is received by autonomous vehicle. In some embodiments, the return pathway is a planar image, while in others it represents a blip, such as, in a ToF system.

As previously stated, LiDAR is a method for determining ranges (variable distance) by targeting an object with a laser and measuring the time for the reflected light to return to the receiver. LiDAR can also be used to make digital 3-D representations of areas on the earth's surface and ocean bottom, due to differences in laser return times, and by varying laser wavelengths. It has terrestrial, airborne, and mobile applications. LiDAR is an acronym of “light detection and ranging” or “laser imaging, detection, and ranging.” Lidar sometimes is called 3-D laser scanning, a special combination of 3-D scanning and laser scanning. Time of flight (ToF) sensors are also not beyond the scope of the current disclosure.

Time of flight (ToF) is a property of an object, particle or acoustic, electromagnetic or other wave. It is the time that such an object needs to travel a distance through a medium. The measurement of this time (i.e. the time of flight) can be used for a time standard (such as an atomic fountain), as a way to measure velocity or path length through a given medium, or as a way to learn about the particle or medium (such as composition or flow rate). The traveling object may be detected directly (e.g., ion detector in mass spectrometry) or indirectly (e.g., light scattered from an object in laser doppler velocimetry).

The Time-of-Flight principle (ToF) is a method for measuring the distance between a sensor and an object based on the time difference between the emission of a signal and its return to the sensor after being reflected by an object. Various types of signals (also called carriers) can be used with ToF, the most common being sound and light. A time-of-flight camera (ToF camera) is a range imaging camera system that resolves distance based on the known speed of light, measuring the time-of-flight of a light signal between the camera and the subject for each point of the image.

Range gated imagers are devices which have a built-in shutter in the image sensor that opens and closes at the same rate as the light pulses are sent out. Because part of every returning pulse is blocked by the shutter according to its time of arrival, the amount of light received relates to the distance the pulse has traveled. As stated, sensing of the distance between a device and an object may be performed by emitting light from the device and measuring the time it takes for light to be reflected from the object and then collected by the device. A distance sensing device may include a light sensor which collects light that was emitted by the device and then reflected from objects in the environment.

In time-of-flight (ToF) three-dimensional (3D) image sensors, the image sensor captures a two-dimensional image. The image sensor is further equipped with a light source that illuminates objects whose distances from the device are to be measured by detecting the time it takes the emitted light to return to the image sensor. This provides the third dimension of information, allowing for generation of a 3D image. The use of a light source to illuminate objects for the purpose of determining their distance from the imaging device may utilize image processing techniques.

In one or more embodiments, radar is used, which will be discussed in greater detail later in the disclosure. With radar, target 420 will be a suitable radar reflective target, and reflective surface will be a suitable reflective surface, such as, a highly conductive plane. In some embodiments, target 420 is a smooth metal (e.g., steel, etc.) plane. However, any highly conductive material having a small skin depth at radar frequencies is not beyond the scope of the present disclosure.

Examples of Multiple Reflection in Calibration

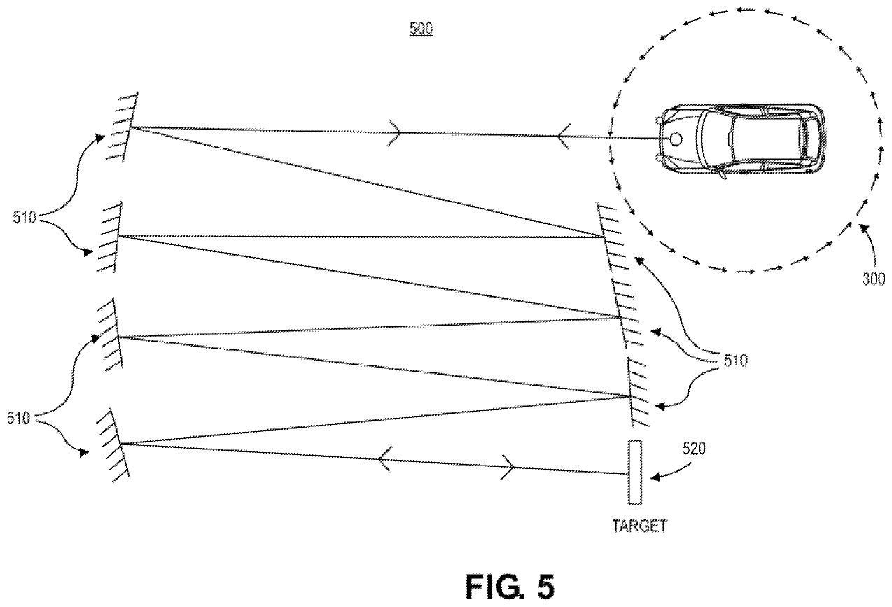

FIG. 5 illustrates an alternate exemplary calibration configuration, according to other embodiments of the disclosure. Again, the inventors of the present disclosure heuristically bootstrap the didactic guidance from FIG. 3 with the inclusion of Autonomous Vehicle Rotation Table calibration environment 300. In one or more embodiments, the electromagnetic wave pathway is increased by way of reflective surfaces 510. In a simple optical embodiment, autonomous vehicle can read the target 520 and estimate the distance solely based on return path. While a plurality of reflective surfaces 510 are depicted, two plane mirrors are not beyond the scope of the present invention. A reference distance can be geometrically determined by the optical pathway.

Example of a Circular Calibration

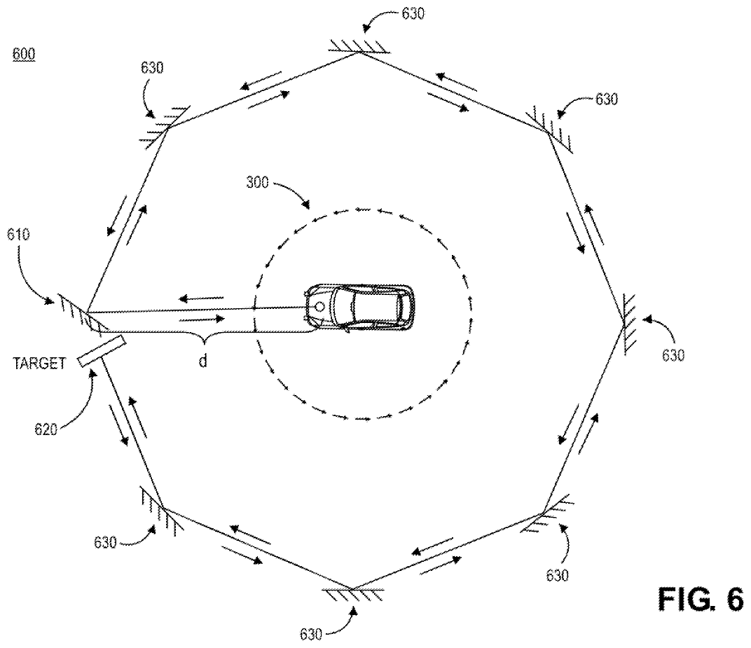

FIG. 6 illustrates an alternate exemplary calibration configuration, according to other embodiments of the disclosure. As can be appreciated by one of ordinary skill in the art, FIG. 6 depicts a substantially circular calibration pattern. In practice, the electromagnetic wave pathway is emitted from autonomous vehicle scene 300, the distance of which is predetermined to be d from target 610. In a round-robin fashion, the electromagnetic wave path progresses throughout reflective surfaces 630 upon reaching target 620, in accordance with previous embodiments. Mathematically, the electromagnetic wave path approaches (2π+1)d.

In some embodiments, coherent lasers are configured to stimulate the pathways. Collimated light is partially useful, as uniform emission is desired. A key point to guarantee good imaging is effectively grabbing lines out of the background. Consequently, laser light could travel the scattering distance with little loss of power (Poynting vector), assuming good alignment. Although not all, many colors could be analyzed pursuant to the needs of the optical system, ToF, lidar, etc.

The inventors have recognized an advantage of using a plurality of colors, such as, RGB used in camera imaging. Upon detection, wavelengths do not all behave the same due to the dispersion relation, at least in part. That is, group and phase velocities travel at different speeds which depend on wavelength. Other chromic and spatial effects can be considered, too. For example, in an RGB camera, different color pixels may be more or less sensitive at a photodiode. Additionally, RGB pixels are separated by small distances. This may make a difference in reducing error. Accordingly, fibers can be stimulated and interrogated by a plurality of wavelengths. The result can be stored in a cloud and accessed by a manufacturer/vehicle at any time. Alternatively, light sources could be broadband light sources and the color analysis could be engendered by way of filtering.

In some embodiments, one or more optical filters are chosen to match the light source. For example, if a midwave infrared (MWIR) LED is used as a light source, a dichroic filter centered between 3-5 μm could be placed over the photodetector. A dichroic filter, thin-film filter, or interference filter is a very accurate color filter used to selectively pass light of a small range of colors while reflecting other colors. By comparison, dichroic mirrors and dichroic reflectors tend to be characterized by the color(s) of light that they reflect, rather than the color(s) they pass. In some embodiments, a controller is used to control the colors presented to the fiber media.

While dichroic filters may be used in the present embodiment, other optical filters are not beyond the scope of the present invention, such as, interference, absorption, diffraction, grating, Fabry-Perot, etc. An interference filter consists of multiple thin layers of dielectric material having different refractive indices. There also may be metallic layers. In its broadest meaning, interference filters comprise also etalons that could be implemented as tunable interference filters. Interference filters are wavelength-selective by virtue of the interference effects that take place between the incident and reflected waves at the thin-film boundaries. In other embodiments, a color wheel with an optical chopper can be used as a filter.

In some embodiments a collimating lens can be used to help direct light from the light source to the object and/or focus incident light to the filter. In optics, a collimator may consist of a curved mirror or lens with some type of light source and/or an image at its focus. This can be used to replicate a target focused at infinity with little or no parallax. The purpose of the collimating lens is to direct the light rays in coaxial light path toward the photodetector.

In some embodiments, photodetectors are used as transducers to sense the light, both background and produced. Photodetectors are sensors of light or other electromagnetic energy. Photodetectors have p-n junctions that converts light photons into current. The absorbed photons make electron-hole pairs in the depletion region, which is used to detect received light intensity. In some embodiments, photodetector are photodiodes or phototransistors. However, any light detecting means, e.g., avalanche, photo-multiplier tube, etc. is not beyond the scope of the present disclosure.

Furthermore, the present disclosure to optical target, as radar target are well within the scope of the present disclosure. The content of which will now be discussed in greater detail.

Example Using Corner Reflector

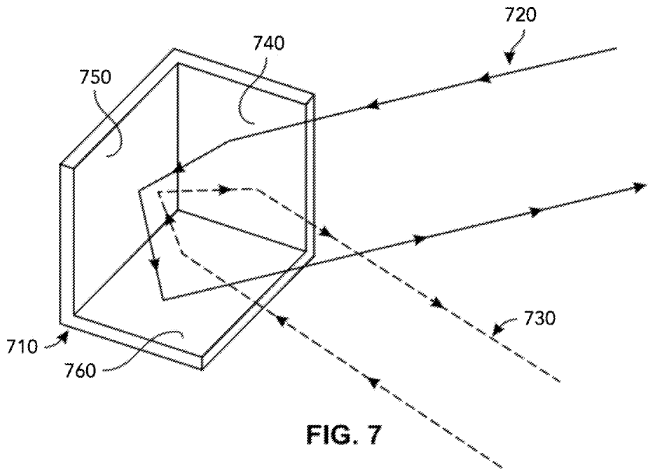

FIG. 7 depicts an exemplary corner reflector 710, according to some embodiments of the disclosure. A corner reflector is a retroreflector consisting of three mutually perpendicular, intersecting flat surfaces, which reflects waves directly towards the source, but translated. The three intersecting surfaces often have square or triangular shapes. Radar corner reflectors made of metal are used to reflect radio waves from radar sets. Optical corner reflectors, called corner cubes or cube corners, made of three-sided glass prisms, are used in surveying and laser ranging.

In practice, an incoming ray 720 is reflected three times, once by each surface 740, 750, 760, which results in a reversal of direction. One skilled in the art can appreciate that the three corresponding normal vectors of the corner's perpendicular sides can be considered to form a basis (a rectangular coordinate system) (x, y, z) in which to represent the direction of an arbitrary incoming ray, 730. When the ray reflects from the first side 760, the ray's x component, is reversed while the y and z components are unchanged. Similarly, when reflected from side 750 and finally from side 760, all components are reversed. Therefore, an arbitrary ray 430 direction travels in leaves the corner reflector 710 with all three components of direction exactly reversed. The distance travelled, relative to a plane normal to the direction of the rays, is also equal for any ray entering the reflector, regardless of the location where it first reflects. The significance of corner reflectors will now be discussed in more detail.

The present embodiment depicts the partial or cross section of a cube. However, any suitable shape is not beyond the present disclosure, such as, cuboid, parallelepiped, rhomboid, etc. The present embodiment generally relates to Millimeter Wave Sensing, while other wavelengths and applications are not beyond the scope of the invention. Specifically, the present method pertains to a sensing technology called Frequency Modulated Continuous Waves (FMCW) radars, which is very popular in automotive and industrial segments.

Radar reflectors, sometimes called Radar Target Enhancers (RTEs), reflect radar energy from other radars so that the target shows up as a larger and more consistent “target.” In one or more embodiments, the target is a boat reflector. As can be appreciated in the maritime arts, a boat in areas with shipping traffic or where fog and low visibility are common, the ability to be seen by radar-equipped ships can make the difference between being seen and being sunk.

Similar to the previous descriptions, radar reflectors work by reflecting radar energy directly back to the radar antenna so that it appears to be a larger target. This would be analogous to retroreflective dots on many highways that make it improve visibility of lane boundaries. These light reflectors use small triangular-shaped prisms that bounce the light around and reflect it precisely back at its source.

The effectiveness of a radar reflector has a quartic relationship to its size. This can be appreciated by a look at how rapidly the RCS (Radar Cross Section) increases with size. Assume that you have three theoretical reflectors of the same design, but of different sizes. The RCS of a given reflector goes up by the fourth power of the radius, resulting in this dramatic increase in effectiveness. For example, a reflector of twice the size of a similar but smaller model has an RCS that is 16-times larger.

In the present embodiment, reflector sides make up a reflector corner. In contrast to the single corner, one in the art can appreciate the broad observation angle of full plane. That is, any radar incident at or above the plane of the hemisphere will return a signal. Other configurations are not beyond the scope of the present disclosure.

To remind, a corner reflector is a passive device used to reflect radio waves back toward the emission source directly. Therefore, a corner reflector is a useful device for Radar system calibration. In general, the corner reflector consists of mutually intersecting perpendicular plates. Common corner reflectors comprise dihedral and trihedral. Corner reflectors are used to generate a particularly strong radar echo from objects that would otherwise have relatively low effective Radar cross section (RCS).

A corner reflector consisting of two or three electrically conductive surfaces which are mounted crosswise (at an angle of exactly 90 degrees). Incoming electromagnetic waves are backscattered by multiple reflection accurately in that direction from which they come. Thus, even small objects with small RCS yield a sufficiently strong echo. The larger a corner reflector is, the more energy is reflected. In some embodiments, tri-hederal shapes are implemented. Trihedral corner reflectors are popular canonical targets for Synthetic-aperture radar (SAR) performance evaluation for many radar developments programs.

Also, not beyond the scope of the present disclosure, synthetic-aperture radar (SAR) is a form of radar that is used to create two-dimensional images or three-dimensional reconstructions of objects, such as landscapes. SAR uses the motion of the radar antenna over a target region to provide finer spatial resolution than conventional stationary beam-scanning radars. SAR is typically mounted on a moving platform, such as an aircraft or spacecraft, and has its origins in an advanced form of side looking airborne radar (SLAR).

The distance the SAR device travels over a target during the period when the target scene is illuminated creates the large synthetic antenna aperture (the size of the antenna). Typically, the larger the aperture, the higher the image resolution will be, regardless of whether the aperture is physical (a large antenna) or synthetic (a moving antenna)—this allows SAR to create high-resolution images with comparatively small physical antennas. For a fixed antenna size and orientation, objects which are further away remain illuminated longer—therefore SAR has the property of creating larger synthetic apertures for more distant objects, which results in a consistent spatial resolution over a range of viewing distances.

As described herein, one aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

### Select Examples

Example 1 provides system for calibrating an autonomous vehicle comprising a platform configured to rotate the autonomous vehicle, the autonomous vehicle includes an emitter and a receiver, a first reflective medium configured to reflect electromagnetic radiation from the emitter, and a target, wherein the first reflective medium is disposed in a pathway between the target and autonomous vehicle.

Example 2 provides a system according to any one of the preceding or proceeding systems and/or methods, wherein emitter and receiver are configured to send and receive LiDAR signals.

Example 3 provides a system according to any one of the preceding or proceeding systems and/or methods, wherein emitter and receiver are configured to send and receive radar signals.

Example 4 provides a system according to any one of the preceding or proceeding systems and/or methods, wherein the target is a trihedral.

Example 5 provides a system according to any one of the preceding or proceeding systems and/or methods, wherein reflective medium is a metal plane.

Example 6 provides a system according to any one of the preceding or proceeding systems and/or methods, wherein emitter and receiver are configured to send and receive LiDAR signal.

Example 7 provides a system according to any one of the preceding or proceeding systems and/or methods, wherein emitter and receiver are configured to send and receive optical signals.

Example 8 provides a system according to any one of the preceding or proceeding systems and/or methods, wherein the target comprise and a symbol or code configured to be identifiable by the autonomous vehicle.

Example 9 provides a system according to any one of the preceding or proceeding systems and/or methods, further comprising a second reflective medium.

Example 10 provides a system according to any one of the preceding or proceeding systems and/or methods, wherein at least one of the first and second reflective media is a mirror.

Example 11 provides a method for calibrating an autonomous vehicle comprising emitting an electromagnetic wave from an autonomous vehicle, illuminating a reflect medium with the electromagnetic wave, reflecting the electromagnetic wave off the reflective medium, illuminating a target with the reflected electromagnetic wave, receiving the reflected electromagnetic wave at the autonomous vehicle, and calculating a distance based at least on the reflected electromagnetic wave.

Example 12 provides a system according to any one of the preceding or proceeding systems and/or methods, further comprising rotating the autonomous vehicle.

Example 13 provides a system according to any one of the preceding or proceeding systems and/or methods, wherein the electromagnetic wave has a spectral bandwidth within at least one of the radar, visible, IR, UV, and LiDAR regions.

Example 14 provides a system according to any one of the preceding or proceeding systems and/or methods, wherein the reflective media is a radar trihedral.

Example 15 provides a system according to any one of the preceding or proceeding systems and/or methods, wherein the electromagnetic wave comprises a plurality of colors.

Example 16 provides a system according to any one of the preceding or proceeding systems and/or methods, wherein the reflective media is a mirror.

Example 17 provides a system according to any one of the preceding or proceeding systems and/or methods, wherein the target comprises a symbol.

Example 18 provides a system according to any one of the preceding or proceeding systems and/or methods, further comprising imaging the symbol.

Example 19 provides a system according to any one of the preceding or proceeding systems and/or methods, wherein the calculation of distance is based at least on a size of the symbol.

Example 20 provides a system for calibrating an autonomous vehicle comprising a means for emitting an electromagnetic wave from an autonomous vehicle, means for illuminating a reflect medium with the electromagnetic wave, a means for reflecting the electromagnetic wave off the reflective medium, a means for illuminating a target with the reflected electromagnetic wave, a means for receiving the reflected electromagnetic wave at the autonomous vehicle, and a means for calculating a distance based at least on the reflected electromagnetic wave.

Example 21 provides an apparatus for calibrating an autonomous vehicle comprising an optical camera configured to image electromagnetic radiation from a predetermined range of directions and a circuit in electrical communication with the optical camera, wherein the circuit is configured to receive an optical image from the optical camera, identify an optical target within the optical image, determine a relative size of the optical target, estimate a distance based at least on the relative size of the optical target a predetermined direction.

Example 22 provides a system according to any one of the preceding or proceeding systems and/or methods, wherein the apparatus is configured to rotate about an autonomous vehicle rotation table and the electromagnetic radiation is configured to reflect off at least one reflective media which is disposed in an optical pathway between the target and optical camera.

### Variations and Implementations

According to various examples, driving behavior includes any information relating to how an autonomous vehicle drives. For example, driving behavior includes how and when the autonomous vehicle actuates its brakes and its accelerator, and how it steers. In particular, the autonomous vehicle is given a set of instructions (e.g., a route or plan), and the driving behavior determines how the set of instructions is implemented to drive the car to and from various destinations, and, potentially, to stop for passengers or items. Driving behavior may include a description of a controlled operation and movement of an autonomous vehicle and the manner in which the autonomous vehicle applies traffic rules during one or more driving sessions. Driving behavior may additionally or alternatively include any information about how an autonomous vehicle calculates routes (e.g., prioritizing fastest time vs. shortest distance), other autonomous vehicle actuation behavior (e.g., actuation of lights, windshield wipers, traction control settings, etc.) and/or how an autonomous vehicle responds to environmental stimulus (e.g., how an autonomous vehicle behaves if it is raining, or if an animal jumps in front of the vehicle). Some examples of elements that may contribute to driving behavior include acceleration constraints, deceleration constraints, speed constraints, steering constraints, suspension settings, routing preferences (e.g., scenic routes, faster routes, no highways), lighting preferences, “legal ambiguity” conduct (e.g., in a solid-green left turn situation, whether a vehicle pulls out into the intersection or waits at the intersection line), action profiles (e.g., how a vehicle turns, changes lanes, or performs a driving maneuver), and action frequency constraints (e.g., how often a vehicle changes lanes). Additionally, driving behavior includes information relating to whether the autonomous vehicle drives and/or parks.

As will be appreciated by one skilled in the art, aspects of the present disclosure, in particular aspects of a perception system for an autonomous vehicle, described herein, may be embodied in various manners (e.g., as a method, a system, a computer program product, or a computer-readable storage medium). Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Functions described in this disclosure may be implemented as an algorithm executed by one or more hardware processing units, e.g. one or more microprocessors, of one or more computers. In various embodiments, different steps and portions of the steps of each of the methods described herein may be performed by different processing units. Furthermore, aspects of the present disclosure may take the form of a computer program product embodied in one or more computer readable medium(s), preferably non-transitory, having computer readable program code embodied, e.g., stored, thereon. In various embodiments, such a computer program may, for example, be downloaded (updated) to the existing devices and systems (e.g. to the existing perception system devices and/or their controllers, etc.) or be stored upon manufacturing of these devices and systems.

The following detailed description presents various descriptions of specific certain embodiments. However, the innovations described herein can be embodied in a multitude of different ways, for example, as defined and covered by the claims and/or select examples. In the following description, reference is made to the drawings where like reference numerals can indicate identical or functionally similar elements. It will be understood that elements illustrated in the drawings are not necessarily drawn to scale. Moreover, it will be understood that certain embodiments can include more elements than illustrated in a drawing and/or a subset of the elements illustrated in a drawing. Further, some embodiments can incorporate any suitable combination of features from two or more drawings.

The preceding disclosure describes various illustrative embodiments and examples for implementing the features and functionality of the present disclosure. While particular components, arrangements, and/or features are described below in connection with various example embodiments, these are merely examples used to simplify the present disclosure and are not intended to be limiting. It will of course be appreciated that in the development of any actual embodiment, numerous implementation-specific decisions must be made to achieve the developer's specific goals, including compliance with system, business, and/or legal constraints, which may vary from one implementation to another. Moreover, it will be appreciated that, while such a development effort might be complex and time-consuming; it would nevertheless be a routine undertaking for those of ordinary skill in the art having the benefit of this disclosure.

In the Specification, reference may be made to the spatial relationships between various components and to the spatial orientation of various aspects of components as depicted in the attached drawings. However, as will be recognized by those skilled in the art after a complete reading of the present disclosure, the devices, components, members, apparatuses, etc. described herein may be positioned in any desired orientation. Thus, the use of terms such as “above”, “below”, “upper”, “lower”, “top”, “bottom”, or other similar terms to describe a spatial relationship between various components or to describe the spatial orientation of aspects of such components, should be understood to describe a relative relationship between the components or a spatial orientation of aspects of such components, respectively, as the components described herein may be oriented in any desired direction. When used to describe a range of dimensions or other characteristics (e.g., time, pressure, temperature, length, width, etc.) of an element, operations, and/or conditions, the phrase “between X and Y” represents a range that includes X and Y.

Other features and advantages of the disclosure will be apparent from the description and the claims. Note that all optional features of the apparatus described above may also be implemented with respect to the method or process described herein and specifics in the examples may be used anywhere in one or more embodiments.

The ‘means for’ in these instances (above) can include (but is not limited to) using any suitable component discussed herein, along with any suitable software, circuitry, hub, computer code, logic, algorithms, hardware, controller, interface, link, bus, communication pathway, etc. In a second example, the system includes memory that further comprises machine-readable instructions that when executed cause the system to perform any of the activities discussed above.

What is claimed is:

1. A system for calibrating an autonomous vehicle comprising:
a platform configured to rotate the autonomous vehicle, the autonomous vehicle comprising an emitter and a receiver.
a first reflective medium configured to reflect electromagnetic radiation from the emitter; and
a target;
wherein the first reflective medium is disposed in a pathway between the target and autonomous vehicle.

2. The system of claim 1, wherein emitter and receiver are configured to send and receive LiDAR signals.

3. The system of claim 1, wherein emitter and receiver are configured to send and receive radar signals.

4. The system of claim 3, wherein the target is a trihedral.

5. The system of claim 4, wherein reflective medium is a metal plane.

6. The system of claim 1, wherein emitter and receiver are configured to send and receive LiDAR signal.

7. The system of claim 1, wherein emitter and receiver are configured to send and receive optical signals.

8. The system of claim 1, wherein the target comprises and a symbol or code configured to be identifiable by the autonomous vehicle.

9. The system of claim 1, further comprising a second reflective medium.

10. The system of claim 9, wherein at least one of the first and second reflective media is a mirror.

11. A method for calibrating an autonomous vehicle comprising:
emitting an electromagnetic wave from an autonomous vehicle;
illuminating a reflect medium with the electromagnetic wave;
reflecting the electromagnetic wave off the reflective medium;
illuminating a target with the reflected electromagnetic wave;
receiving the reflected electromagnetic wave at the autonomous vehicle; and
calculating a distance based at least on the reflected electromagnetic wave.

12. The method of claim 11, further comprising rotating the autonomous vehicle.

13. The method of claim 11, wherein the electromagnetic wave has a spectral bandwidth within at least one of the radar, visible, IR, UV, and LiDAR regions.

14. The method of claim 13, wherein the reflective media is a radar trihedral.

15. The method of claim 13, wherein the electromagnetic wave comprises a plurality of colors.

16. The method of claim 13, wherein the reflective media is a mirror.

17. The method of claim 11, wherein the target comprises a symbol.

18. The method of claim 17, further comprising imaging the symbol.

19. The method of claim 18, wherein the calculation of distance is based at least on a size of the symbol.

20. An apparatus for calibrating an autonomous vehicle comprising:
an optical camera configured to image electromagnetic radiation from a predetermined range of directions; and
a circuit in electrical communication with the optical camera configured to:
receive an optical image from the optical camera;
identify an optical target within the optical image;
determine a relative size of the optical target;
estimate a distance based at least on the relative size of the optical target a predetermined direction;
wherein the apparatus is configured to rotate about an autonomous vehicle rotation table and the electromagnetic radiation is configured to reflect off at least one reflective media which is disposed in an optical pathway between the target and optical camera.
